(19) United States
(12) Patent Application Publication
(10) Pub. No.: US 2017/0278180 A1
(43) Pub. Date: Sep. 28, 2017

(54) COMPUTERIZED BROWSING AND BIDDING SYSTEM FOR UNINDEXED MERCHANDISE

(71) Applicant: Forrest Landry, Rancho Santa Fe, CA (US)

(72) Inventor: Forrest Landry, Rancho Santa Fe, CA (US)

(21) Appl. No.: 15/619,162

(22) Filed: Jun. 9, 2017

Related U.S. Application Data
(63) Continuation of application No. 14/980,379, filed on Dec. 28, 2015.
(60) Provisional application No. 62/097,058, filed on Dec. 27, 2014.

(51) Int. Cl. G06Q 30/06; G06Q 30/08

(52) U.S. Cl. CPC G06Q 30/0643; G06Q 30/08

(57) ABSTRACT

A business method for facilitating a buyer-pushed sales transaction and associated technological systems and computer-implemented methods are disclosed. One method includes rendering a first image of a physical environment in a client application, accepting a navigation command via the client application, and rendering, in response to the navigation command, a second image of the environment. At least two items of physical merchandise are visible in the second image. The method also comprises accepting a selection of a location on the second image. The method also comprises storing a set of coordinates in response to the selection. The method also comprises accepting a bid, and storing a bid package in a memory. The bid package includes and associates: (i) the bid; (ii) the set of coordinates; and (iii) a user identifier. The bid is for one of items of merchandise.

### CROSS-REFERENCE TO RELATED APPLICATIONS

This application is a continuation of U.S. patent application Ser. No. 14/980,379 filed Dec. 28, 2015, which claims the benefit of U.S. Provisional Application No. 62/097,058 filed Dec. 27, 2014, the disclosures of which are incorporated by reference herein in their entirety for all purposes.

### BACKGROUND

Online shopping generally involves searching for an item by applying a search query against a database of items. The items for sale are generally indexed individually, or as a set of units that are sold together, and are placed in the database so that they will be available for a targeted search query. In the most basic forums, such as online classifieds, a potential seller must index their item by providing a key-word-searchable text string that describes the item, and an image taken specifically for the purposes of selling that one item. If a large number of items are to be sold, even this most basic indexing procedure can be cumbersome.

Online shopping also involves an overall process of applying a search query, receiving results, and reviewing the results. This process is generally conducted in a manner that is not at all related to the manner in which humans traditionally search for items in a physical space. The results for a given search string in an online shopping flow are generally provided in a list format. Occasionally, additional information will be presented with the search results, such as information regarding other complementary products that are sometimes purchased with the item that was the subject of the search query itself. Filters are also sometimes provided to trim the results for a particular limitation such as an offering price in a given range, or a specific brand for the item. However, the overall presentation of potential items for purchase is still generally similar to a traditional catalogue with all of the results presented in columns or rows in the form of descriptive text and a thumbnail image of the item.

### SUMMARY

Technology is disclosed herein to facilitate a sales transaction for physical items over the Internet without anyone having to inventory, price, describe, and enter/encode each item potentially offered for sale. The physical items are unindexed by the seller, and instead the overall transaction facilitated by the disclosed technology is pushed by the buyer. Using the disclosed technology, the seller provides an unindexed global declaration of the items they are interested in offering for sale, and the buyer both identifies the items they are interested in purchasing and initiates the sales transaction via an opening bid for those items.

As a result of this technology, the barrier to entry for occasional online sales of low cost and unique non-commodity items is significantly reduced to the point of making such transactions profitable. The disclosed technology and approaches are particularly amenable to the sale of diverse items which are sold in small numbers, have low absolute cost or retail margin, and are offered by merchants with inventories having high change frequency. For example, most yard-sale items are not offered for sale on the Internet unless they are of substantially high enough margin that the effort of indexing them via on online classified is worthwhile. Usually the indexing effort associated with describing, pricing, photographing, and entering into inventory each unique physical item costs more in time, labor, and effort than any possible margin associated with the sale of the item itself. This makes such items too expensive for retailers to offer over the Internet rather than in a physical store, and prevents merchants interested in selling these items from realizing the benefits of sales over the Internet. More broadly, the disclosed technology improves the fields of electronic inventory management and electronic marketing, and provides a technical solution to the technical problem of indexing products in a computerized virtual store environment.

The disclosed technology includes a set of aspects that contribute to the technical problem identified above. First, a virtual spatially navigable presentation of a physical location is provided to a buyer via a client application that is in communication with a server. A buyer operating the client application can navigate within the presentation to find items they are potentially interested in. For example, a buyer could be presented with images of a physical store and navigate through the store by clicking on navigation buttons provided on their display. Browsing the physical space is much more intuitive that browsing a database via search queries. Second, the buyer can then use the disclosed technology to select a specific item they are interested in from an undifferentiated image of the physical location. The image is undifferentiated in that the displayed items that are available for sale do not have to be separately digitized, inventoried, and placed in a database. The potential buyer will then create a bid for an item by identifying coordinates of that item in a graphical rendering of the spatially navigable presentation. As a result, the item is identified by the buyer from the client application without the specific item having to be separately indexed by the seller. For example, once the buyer navigates to an area of the store with an item they want to purchase, the buyer could click on the item and enter in a bid for that item. This would result in a bid being created with coordinates describing where the buyer clicked. Third, the image of the item is reconstructed for the seller using the coordinates provided by the buyer. As a result, a graphical rendering of the item can then be generated for the seller's benefit when considering the bid. In keeping with the prior example, the image that the buyer saw when they created their bid would be reconstructed for the seller using the coordinates that were saved along with the bid. The seller would then be able to see exactly which item the buyer clicked on even though that item was not indexed by the seller prior to being selected by the buyer.

The proposed approach provides an additional technical advantage in that, although information is ultimately being provided via images on which the buyer selected an item and an image through which the seller identifies the item, the number of image files that need to be stored and transmitted through the Internet is limited. Since only the coordinates within the virtual spatially navigable presentation of the physical location need to be stored with the buyer's bid, and the image can be reconstructed for the seller via that minimal set of information, the image itself, as seen by the buyer, does not need to be stored and uploaded from the client application to the server. As the server will ultimately distribute bids to potential sellers for consideration, the efficient transmission of this information provides a significant benefit to the efficiency of the overall system.

The transaction flow described above can be considered a buyer-pushed transaction because the buyer identified the item for sale, and created the initial bid for the transaction. As a result, the seller did not need to create a price for the item or index it in any way. In certain approaches, the bid generated by the potential buyer can be associated with a limitation on acceptance of the bid. This further alleviates the issue with inventorying and indexing because a buyer is able to place a protected bid without knowing more about the product than what is shown in the image. As such, buyers will be more secure in attempting to purchase items for which little information has been provided. This feature is particularly beneficial in the field of sales for unique items because their consistency and quality is not usually something that can be taken for granted. For example, the bidder could say that they will purchase a rare book, but only if it meets certain conditions such as not having any torn or missing pages.

In specific approaches, the disclosed technology includes a computerized method executed by a client application in communication with a server comprising rendering a first image of a physical environment in the client application, accepting a navigation command via the client application, and rendering, in response to the navigation command, a second image of the physical environment in the client application. The at least two items of physical merchandise are visible in the second image. The method also comprises accepting a selection of a location on the second image via the client application, storing a set of coordinates in response to the selection, accepting a bid via the client application, and storing a bid package in a memory. The bid package includes and associates: (i) the bid; (ii) the set of coordinates; and (iii) a user identifier. The bid is for one of the at least two items of physical merchandise and is placed by a user who is uniquely associated with the user identifier.

In specific approaches, the disclosed technology includes a non-transitory computer-readable medium storing instructions for executing, in combination with a memory and a processor, a method comprising: rendering a first image of a physical environment in the client application, accepting a navigation command via the client application, and rendering, in response to the navigation command, a second image of the physical environment in the client application. The at least two items of physical merchandise are visible in the second image. The method also comprises accepting a selection of a location on the second image via the client application, storing a set of coordinates in response to the selection, accepting a bid via the client application, and storing a bid package in a memory. The bid package includes and associates: (i) the bid; (ii) the set of coordinates; and (iii) a user identifier. The bid is for one of the at least two items of physical merchandise and is placed by a user who is uniquely associated with the user identifier.

The disclosed technology can be used in combination with a business method for facilitating a buyer-pushed sales transaction for an unindexed item of merchandise between a buyer and seller. The party conducting the business method can be referred to as the facilitator. Aspects of the disclosed technology can be offered via a client application such as a web-based downloadable application offered by the facilitator for downloading to a client device associated with a potential buyer. Aspects of the disclosed technology can also be offered via seller and buyer web portals offered via the Internet from the facilitator's servers. These portals can also be referred to as member portals and can offer both seller and buyer side functionality. The business can generate revenue by collecting a portion of each sales transaction from either the buyer or seller consummated through use of the provided technology, or by charging members for the ability to utilize the provided technology. Traffic can also be driven to the facilitator's business by allowing parties to consummate transactions without using the provided technology. This would provide an added incentive for seller's to provide images of their products and stores via the facilitator's business because it would in essence be a form of free advertising for their products.

In specific approaches, the business methods include a method for facilitating a buyer-pushed sales transaction between a buyer and a seller comprising notifying a technician of a physical location containing a set of at least two items of physical merchandise. The method also comprises receiving an upload package from the technician. The method also comprises providing, using data in the upload package, a virtual spatially navigable presentation of the physical location to the buyer via a client application. The method also comprises receiving a set of coordinates as part of a bid package for an item in the set of at least two items from the buyer. The coordinates are determined based on a selection from the buyer on an image in the virtual spatially navigable presentation. The method also comprises facilitating identification of the item by the seller using the coordinates. The method also comprises delivering data from the bid package to the seller.

### BRIEF DESCRIPTION OF THE DRAWINGS

FIG. 1 illustrates a flow chart of methods that can be conducted by a client application to generate a bid package in accordance with certain aspects of the disclosed technology.

FIG. 2 illustrates a display with a navigation interface overlain on an image from a virtual spatially navigable presentation of a physical location in accordance with certain aspects of the disclosed technology.

FIG. 3 illustrates a display with a selection interface overlain on an image from a virtual spatially navigable presentation of a physical location in accordance with certain aspects of the disclosed technology.

FIG. 4 illustrates a display with an image from a virtual spatially navigable presentation of a physical location displayed alongside a bid entry interface in accordance with certain aspects of the disclosed technology.

FIG. 5 illustrates a network diagram of a buyer device, seller device, and sever means in accordance with certain aspects of the disclosed technology.

FIG. 6 illustrates a flow chart of methods for capturing images of the physical location and creating a virtual spatially navigable presentation of the physical location.

FIG. 7 illustrates various nodes in a flow chart of a business method for facilitating a buyer-pushed sales transaction between a buyer and a seller.

### DETAILED DESCRIPTION

Reference now will be made in detail to embodiments of the disclosed invention, one or more examples of which are illustrated in the accompanying drawings. Each example is provided by way of explanation of the present technology, not as a limitation of the present technology. In fact, it will be apparent to those skilled in the art that modifications and variations can be made in the present technology without departing from the scope thereof. For instance, features illustrated or described as part of one embodiment may be used with another embodiment to yield a still further embodiment. Thus, it is intended that the present subject matter covers all such modifications and variations within the scope of the appended claims and their equivalents.

Specific detailed implementations of the technology used to facilitate buyer-pushed transactions for globally declared unindexed items are described herein below. The first section describes a client application operating in combination with a server to receive buyer interest for the unindexed items with de minimus upfront effort on the part of the seller. The second section describes the network architecture for administrating both the seller and buyer side of the transaction. The final section describes a business method for facilitating a buyer-pushed sales transaction between a buyer and a seller using the technology disclosed in the prior sections.

Client-Side Technical Methods and Systems

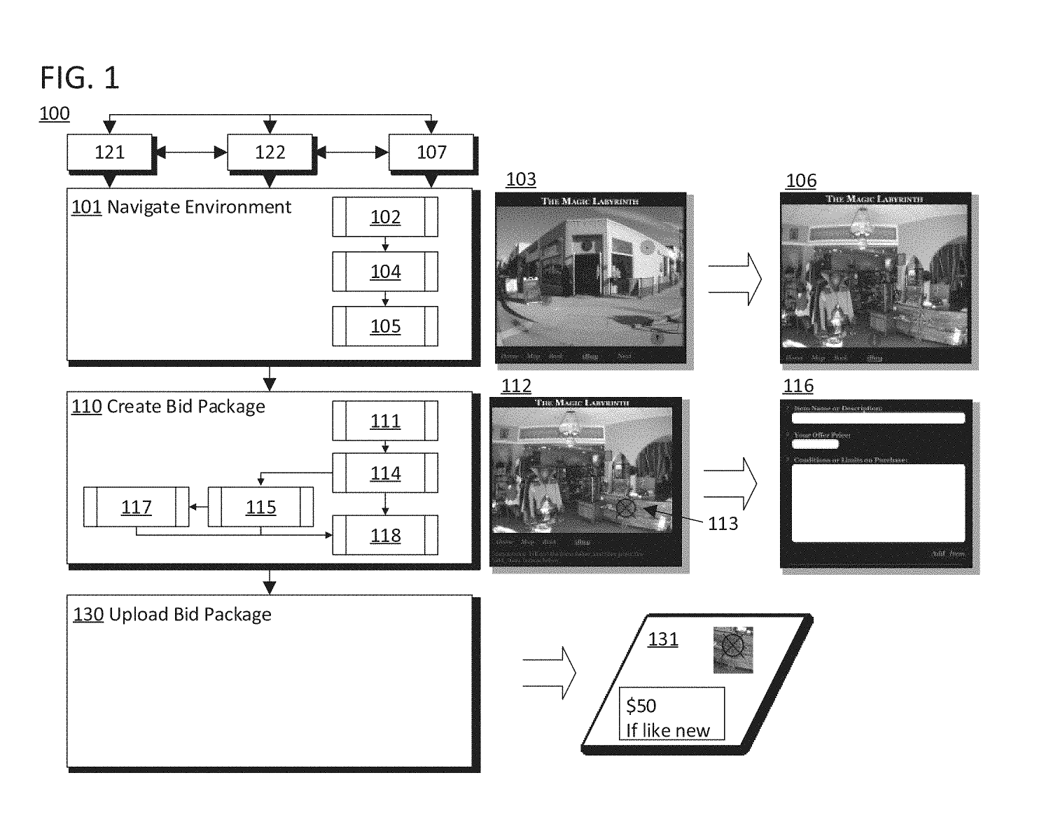

FIG. 1 includes flow chart 100 which illustrates a set of computerized methods executed by a client application in communication with a server. The client application can be an Internet based web application running in a web browser on a workstation or a mobile device such as a smartphone. The client device can alternatively be an application provided via a kiosk. However, such an application could still be an Internet based web application. The client application could communicate with the server using a common operating system and web browser. References to the client application include the data and instructions supporting the instantiation of the client application as well as the instantiation of the client application as experienced by a user and as interpreted by the server. The information provided by the server and rendered using the client application could be provided using HTTP and instructions encoded in HTML, CSS, and Javascript. The server and client application could communicate via a TCP/IP connection. The client application could provide information to the server using an HTTP Post or web socket streaming.

The individual steps of flow chart 100 can be conducted by the client application operating in combination with a processor and a memory. Each rendering step in flow chart 100 can include providing encoded instructions to a compiler and applying them to the document object model of a browser or the customized application model of the application itself. Each providing step in flow chart 100 can include retrieving instructions from the memory and applying those instructions to the processor. Each accepting step can involve an event listener receiving an indication that an input was received by the application and storage of data representing the accepted command or data in a temporary cache. Each storing step can involve writing the data in a memory and addressing the data via the client application.

In process 101, a potential buyer utilizes the client application to virtually navigate through a physical environment. Process 101 can involve a step 102 in which a first image of a physical environment is rendered in the client application. The physical environment could be a physical retail location such as a store, a warehouse, a garage sale, a flea market, or any physical environment containing physical merchandise. In one example, the first image could include the doorway of a store and the interior of the store, or an intermittent portion of the store between merchandise displays. As illustrated in FIG. 1, the rendering can be provided via a display and can appear as in display 103 in FIG. 1.

Virtual navigation in process 101 can be conducted in a manner analogous to actual physical movement through a space. For example, process 101 can continue with a step 104 and 105 in which a navigation command is accepted via the client application and a second image of the physical environment is rendered in the client application in response to the navigation command. The navigation command could be a command such as “move left” or “look right”, in which case the responsive second image would show a different portion of the physical environment corresponding to what someone would have seen if they had moved left or looked right in the physical space. As illustrated in FIG. 1, the rendering can be provided via a display and can appear as in display 106 in FIG. 1 where, in this example, the second image illustrates an entry way of a store where multiple items are available for sale. The second image include can include at least two physical items that are being offered for sale in the physical environment. The first image can also include items for sale, or it could be an image from outside a store or from a transition point in the physical environment in which no physical items of merchandise are visible.

The navigation command accepted in step 104 corresponds to a physical movement through the physical environment. The relationship between the first image and the second image correlates with the physical movement. The movement can mimic the movement of a user through the physical location. As illustrated by display 103 and 106, the navigation command could be a “move forward” command to navigate into the front door of the store. The physical movement can alternatively be a temporal transition through the physical environment without a corresponding spatial translation. In this situation, the relationship between the first image in display 103 and the second image in display 106 would correlate with the temporal transition and not include a spatial translation. The alternate temporal views can be accessed via a specialized navigation interface, such as a timeline or a set of arrows rendered by the client application. Temporal navigation interfaces can be displayed in combination with or alternatively to spatial navigation interfaces.

The availability of temporal physical navigation allows for various applications. For one example, the same item can be viewed at different times which enables the display of the item in different states (e.g., opened or closed, front and back, etc.). Using temporal navigation, the same portion of a store or the same item can also be displayed in different seasons. Furthermore, items can be displayed that are not even available for sale at the actual physical environment at the present time. Sellers that offer their goods via the system will therefore be able to collect and access a record of items sold in a specific environment at previous times. Furthermore, since additional aspects of the technology described below enabled buyer-pushed transactions, buyers can use the client application and temporal browsing feature to express interest in items that are no longer present. As such, a seller is able to collect information about consumer interest for items of inventory that would not otherwise be present for a consumer to view. In response, a seller could decide to bring an item back into production, or a buyer could be provided with the opportunity to commission the production or provisioning of an additional unit. For example, a store that offered a specific article of clothing in spring might be able to collect information about user interest in that item during the winter, and would know to rerelease the item in the following spring.

Navigation can be conducted through the use of a navigation interface. The navigation interface can be provided by the client application, and may include a visible rendering on the display of a client device. For example, the images of the physical space could have an overlay of icons, drawn over the image, indicating to the customer opportunities to turn, pivot, and navigate to alternate views. The navigation interface could be displayed constantly as an overlay over the images of the physical space, it could be presented alongside the physical space, or it could alternatively appear in response to a key press or a mouse hover event.

The type of navigation interface utilized will depend on the format of the presentation of the physical environment. In general, the presentation will include a set of images of the physical environment through which a potential buyer can navigate. The images can therefore be defined as a set of components of the presentation of the physical environment. The images could be individually downloaded by the client application from the server, and in some approaches each presented image will represent a new web page provided to the client application. However, the image could also be presented in a dynamic view on a single web page. The presentation of the physical environment could also be downloaded, as in step 107, before any navigation commands were accepted. The presentation as a whole could be stored by the client application and the first and second images shown in steps 102 and 105 could be rendered without requiring a request for information from the client application to the server. Hybrid approaches could also be adopted in which portions of the overall presentation were downloaded and stored by the client application to allow a certain degree of navigation without calls to the server. For example, portions of the presentation could be provided on a store-by-store or department-by-department basis.

The presentation could be a linear path set by the seller through the physical environment in the form of a sequence of images or a video. In this case, the navigation interface could be as simple as a play, pause, back, and fast forward interface similar to what is used to scan through and play back a video, or even as simple as a forward and backward instruction along a pre-scripted path through the physical space. The navigation interface for this form of presentation could include a zoom feature to zoom in on any of the presented images.

The presentation could also involve more complex formats. For example, the presentation could be a set of linked way points defined by physical translational movement through the space with multiple paths through the way points. As another specific example, the presentation could involve a fluid stream of images through which a user had complete free movement and spherical free look navigation options. These presentation formats and navigation interfaces could also involve a zoom feature to apply a zoom to any of the presented images. These more complex presentations could involve a navigation interface that is rendered in the client application with a zoom command interface, a turn command interface, a move forward command interface, a move backward command interface, and an azimuth command interface. Different movement commands could be available based on which way point the client application was currently providing. As another example, a down arrow with a line icon could indicate a position that the user can navigate to, that when clicked on, causes the client application to display an image taken from that position and in a similar orientation as previously provided. The navigation interface could provide both temporal and spatial physical navigation via separate sets of interfaces for those two kinds of navigation. Temporal navigation could also include placement of an icon on a timeline displayed underneath or alongside the image.

The navigation interface can be augmented with additional information and command interfaces to provide additional functionality. Each additional interfaces and functionality described immediately below can be used in combination or as alternative additions to the client application. The additional information can be provided by the seller if they are interested in providing such information for particular high value items.

The navigational environment can temporarily transition from providing a way to navigate through the physical environment in an analogous fashion to the way humans navigate through a physical environment to some other form of navigation. These temporary transitions can correspond with multiple scales of interest such as digging down to details on a specific location within a given store to zooming out to see all of the stores within a large geographical area broken down by product categories. Although categorizing a store would involve some indexing effort on the part of a seller, the effort required to select a particular category once when setting up a store would be de minimus compared to indexing specific items for sale. The temporary transitions could also include switching between temporal and spatial navigation.

The navigation environment may provide an icon for switching the view into a detailed view that focuses on one location in the physical environment. The navigation interface can also be arranged so as to provide orbits around specific locations in the physical environment so that the displayed images will constitute a 360° view focused on that location. Once a detailed view is opened, the navigation interface might provide icons to shift from one detailed view to another such as from one shelf of the store to another, or one single item details page to another without having to use a physical navigation equivalent to physically navigate between the two shelves or items. This functionality can be provided via multiple icons indicating the availability of detailed views, close ups of specific items or areas, or the option to manipulate specific items.

The navigation interface may provide an icon for switching the view to a map view for faster navigation through the physical environment. The map interface can display a floor plan for a physical environment with “jump to” icons that enable the buyer to not only get an indication of their current position and direction on the map, but also to directly transition to a new position and direction of view. This enables faster navigation through larger and more complex spaces such as large stores. In addition, the map has multiple levels of abstraction so that it can be used to navigate to multiple stores in a larger physical environment in the same way that one would jump to different locations in a single store. At a certain level of abstraction, the map view can give way to a category or index view that allows a buyer to browse for stores by shop name, location, or product type. Navigation via jumps can also be provided via positional hyperlinks drawn over images of the physical location or provided alongside images of the physical location. For example, one store owner might offer promotions for complementary goods provided at a different store by providing a positional hyperlink to that store alongside their products.

The navigation interface may also provide an icon representing actions that the user can take besides physical navigation within the environment. For example, icons can indicate the opportunity to manipulate objects in the environment such as flipping them over, changing their color, flipping them, opening them, turning them on or off, or otherwise interacting with the various items displayed in the images of the presentation. The interactions could trigger the display of multiple images reflecting a result of whichever interaction was selected by the user. The process and linking logic utilized for physical navigation could be applied equally in this case since the client application and server will not generally distinguish between an image being delivered due to an interaction or an image being delivered in response to a physical navigation in the physical environment.

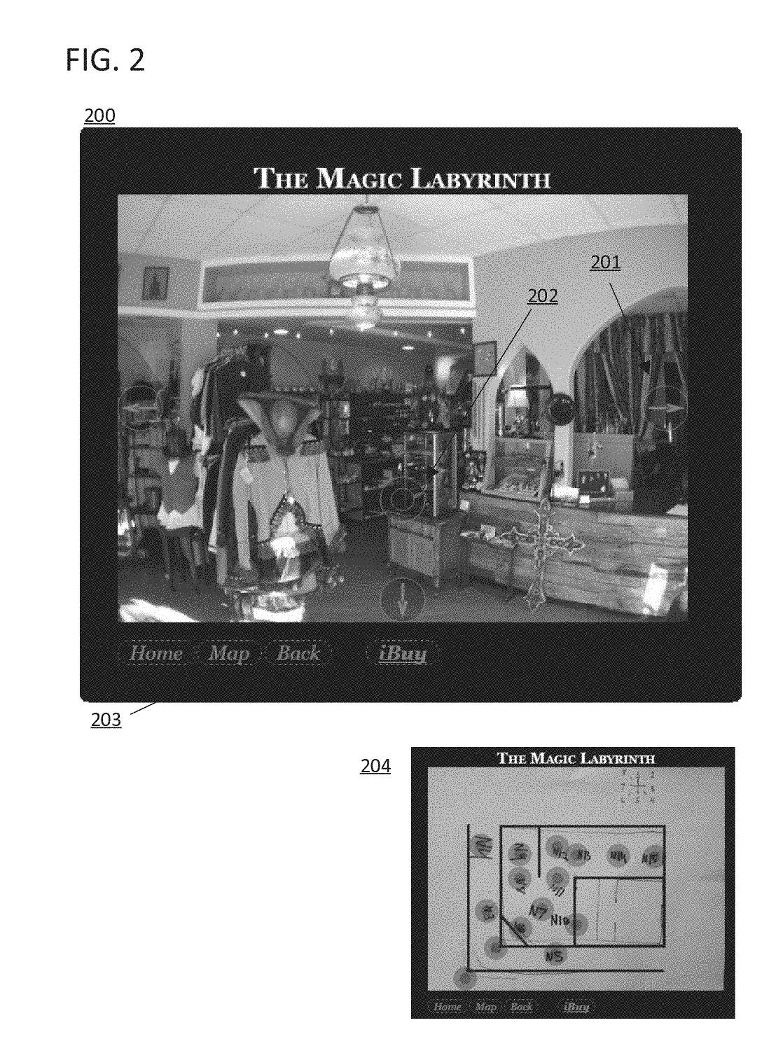

FIG. 2 provides an illustrative display 200 rendered by a client application that highlights some of the features described above. The display includes navigation arrows such as arrow 201 overlain an image in a virtual spatially navigable presentation of a store called “The Magic Labyrinth.” Display 200 includes some of the features described above including icon 202 which indicates that a user can focus on the rack of items at the center of the image. In response to the selection of this icon, a close up image of the rack would be provided for the buyer to review. Display 200 also includes a “Map” command interface 203 which would allow the buyer to switch to map view 204. Map view 204 includes icons that indicate the availability of “jump” navigation as described above.

Utilizing a presentation that is based on components that comprise set images with navigation between the fixed images is a beneficial presentation option in terms of providing the degrees of freedom and functionality described in the prior paragraphs. As opposed to a presentation comprising stitched omnidirectional views with special viewing software, static fixed images provide much more flexibility in terms of how those images can be linked and associated. This is because image stitching algorithms essentially impose a particular relationship between the components of the presentation instead of leaving that to the designer of the presentation. Furthermore, set images provide support for location maps, detailed view, temporal browsing, outside vs. inside out view shifting, horizontal and vertical browsing across shelves, etc. all with a single client application. As long as the user defines the relationships, any kind of interaction with the physical environment can be model using the same linking logic and conditional states. The use of this class of presentations also allows for the application of traditional image map technology and the use of conventional code bases such as HTML, CSS, and Javascript which ensures system compatibility in a traditional HTTP client/server framework and a common language through which potential sellers and developers can enhance the functionality of the system.

The navigation interface can be augmented with an additional windows or views to provide information in context with the current image of the physical environment. These windows can be referred to as context windows. For each image presented, another region of the display, such as the lower half, can present a description of the location being viewed or more information regarding items in the image. For example, story elements regarding a guided tour through the environment, links to other portions of the physical environment or other informative websites, instructions, other diagrams, images, and other information could be provided in the context window. The context window, or an icon, could provide access to an audio clip associated with the displayed image of the physical location. The association between the images taken from specific locations, specific directions, and specific times can display specific object states with individual story elements, links, game elements, or content. The views can include any HTML composable content and can be managed via a common data-file that is automatically loaded into the client application. The data file can be loaded when the client application is loaded into a browser, when a user first logs in to the client application, or when the presentation for a particular physical environment is provided to the client application.

The context windows can be context pages that are actual and complete HTML pages or files of their own. The context windows can also be setup so that they can be discovered and crawled by search engine crawlers from a common index page. As a result, the unindexed content of the physical environment can be optionally indexed by providing indexing information in context views which are then crawled by a search engine. Therefore, pages and images of specific “locations” in the physical environment can be discovered by their text content, as in a general internet search. Any of these pages or views can be found and presented as a link item within a set of search results from a search engine. Clicking on the link items or a thumb nail of the search results will then automatically load that “location” and start the navigation interface and client application at that point as if the user had navigated to that point through the physical navigation interface.

The use of interactivity with the physical environment, context windows, guided tour navigation, and any combination therefore provides the opportunity for the introduction of gamification and story options for the client application. Since navigation can include a pre-scripted path with a ‘next’ navigation feature which has the effect of walking a user through a given space as if on a guided tour, there is the potential for a seller to combine the shopping experience with a linear story that flows through the physical environment. Through the use of these elements the data map of the presentation can also specify any arbitrary relationship between the user's interactions with the navigation interface and the presentation. In addition, use of a temporary cache associated with the client application, or a web browser's own persistent memory, can include storing the state of the user's interactivity to provide further gamification elements. For example, perhaps access to a special room in the store can only be provided if a user first interacts with an item in the store to find a secret key to that room. Gamification elements can be added to any sale site process integrating this infrastructure by adding additional conditional elements and opportunities based on various customer behavioral events and sequences of interactions.

The navigation technology described above provides certain benefits as compared to traditional methods of allowing users to search for items in an electronic commerce environment. First, it is well known that people are far more readily able to integrate and remember content when there is a consistent context and story. Locations which otherwise would be hard to present or explore become consistently and fairly easily presentable and documentable. In regards to the percentage of brain capacity associated with various sensory modalities, there is far more support for visual information processing than there is for linguistic understanding. People are naturally organized to process visual and spatial information—to browse images and remember spaces—far more readily than they are able to remember text. Instead of having to remember a particular keyword or URL used to locate a specific item they were interested in, users can utilize their stronger spatial-visual memory to recall the location of an item. In addition, it is more likely that a user will recall an item when it is presented to them in context as opposed to in a static catalogue. Asking people to search for items in a catalog is far more cumbersome than simply asking them to point to what they want and to then have them describe any special features or functionality that they need.

Flow chart 100 continues with process 110 in which a potential bidder utilizes the client application to provide a bid on an item in the physical environment. Process 110 is another aspect of the disclosed technology which allows the transactions to be buyer pushed. Since the potential bidder is able to start the sales transaction be selecting an item from a set of globally declared unindexed items, the seller incurs a minimal upfront contribution to the overall transaction. Furthermore, the buyer is able to express interest in any item displayed in the presentation of the physical environment. The buyer can even bid on items that the seller had not considered selling.

Process 110 includes step 111 of accepting a selection of a location on the second image 106 via the client application. Step 111 can involve switching the navigation interface into a special mode to accept the selection of the aforementioned location. For example, a user could select a user interface element like a button or press a special hot key to switch the mode of the navigation interface and then click on the image of the physical environment to select a particular location. As illustrated in display 112, a cursor 113 can highlight the location selected by the buyer after the selection is made. Notably, there are at least two items of physical merchandise that are visible in display 112. Therefore, the selection made in step 111 allows a buyer to express interest in a particular item even though the presentation did not single out the item under cursor 113 for sale.

The user experience features for step 111 and the client application technology utilized to implement step 111 can take on various forms. As mentioned, user interface element such as a “buy” or “bid” button can be selected by the user when they see an item in an image of the presentation that they are interested in acquiring. This can switch the client application into a mode where the user can select an item on the image. Selection can involve clicking on a specific location in the image, or a mouse down and drag interaction to define an area occupied by the item of interest. Selection can also involve manipulating the physical navigation and zoom commands until the entire display of the client application is focused on the item of interest followed by the entry of a command to indicate that the area currently set by the area of the display is itself the location of interest. Step 111 can involve an event listener being activated by the client application to listen for an input from the user. For example, an event listener can wait for an “on click” event on the page. An event handler can then be programmed to store the location at which the click occurred for a later step used to assemble the overall bid package. Other equivalent event listeners and event handlers can be used to prime the client application for selection of the location and to store the location for later use.

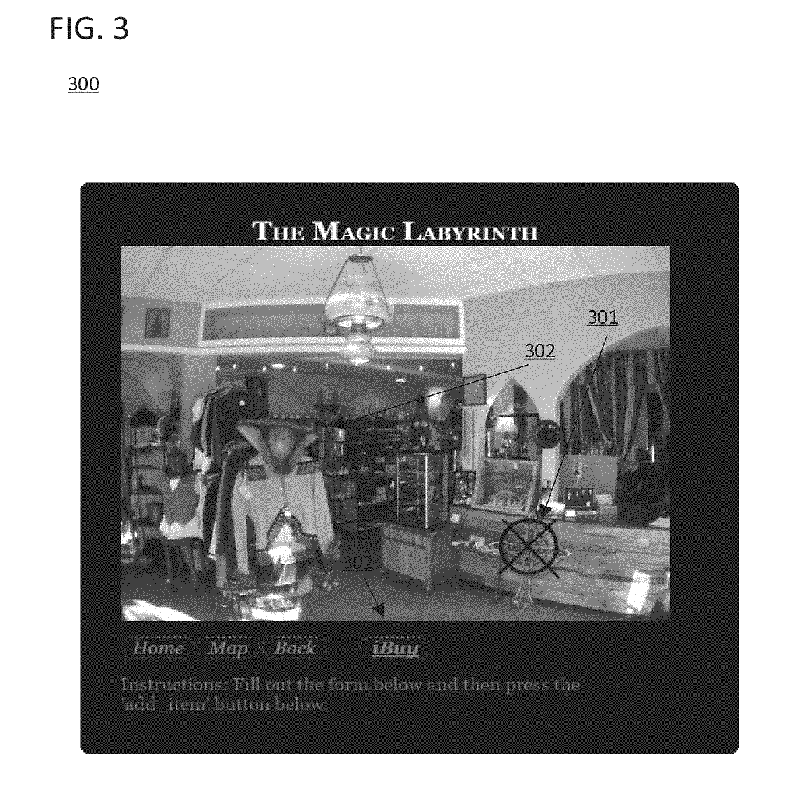

FIG. 3 illustrates display 300 which shows an image of the same physical location in display 200 except a cursor 301 has been added to the image to highlight an item the buyer is interested in. As illustrated in display 300, a particular interface component such as iBid button 302 was previously selected so that the next input by the user on display 300 would result in the selection of a location. In this example, the buyer selected the iBid button 302, and then select the item under cursor 301 by clicking on that portion of the image. Notably, there are two items of physical merchandise that are visible in display 300—the item underneath cursor 301 and item 302. Therefore, the selection made in step 111 allows a buyer to express interest in a particular item even though the presentation did not single out the item underneath cursor 301 for sale. Indeed, both items in display 300, and any other item in the presentation, are items of physical merchandize that were not indexed and are not represented electronically on the Internet in any form besides there visual appearance in the presentation. Furthermore, the two items are individually purchasable and are separately offered by the seller. The item underneath cursor 301 was unindexed and was globally declared along with all of the other items that the seller included in the presentation of the physical environment. Far more than two items of merchandise could be included in display 300 and the same result would arise from the disclosed technology—the buyer could identify an item they were interested in without the seller having to distinguish that item from any other in the presentation.

As mentioned previously, the combination of the technology involved in processes 101 and 110 provide certain benefits in that the items in the presentation do not need to be individually index by sellers. An additional benefit is that multiple views of a set of items can be provided with the same number of images that would be required to view a single item in conventional systems. In one implementation of process 101 and step 111, the first image in the display includes at least two items of physical merchandise from a first angle and the second image includes the same two items from a second angle. The first angle and the second angle are not equal. As a result, using only two images, two items that are separately offered for sale can be viewed from two different angles, which would otherwise require four separate images. Merchants that have diverse and unique offerings greatly benefit from this technology because the required number of views for multiple views of a large number of items would otherwise follow a power law and become exponentially larger and prohibitively data intensive.

As shown in process 110, step 111 can followed by step 114 of storing a set of coordinates or an offset with respect to the presentation in response to the selection made in step 111. The coordinates can be part of an offset with respect to the presentation. In one example, the offset is a set of two numerical values that describe an x-coordinate and a y-coordinate of a particular image in the presentation. To use the example of FIG. 3, the offset could be the coordinates at the center of cursor 301 along with an identification of the image shown in display 300. In situations where the presentation was a simple sequence of images presented on individual web pages, the offset could be x and y coordinates on the web page itself. In a more complex presentation, the offset could also include an azimuth value and a zoom value from a way point in the presentation from which spherical free look functionality was provided.

The purpose of storing the offset in step 114 is to be able to recreate display 112, or a portion thereof, for the seller as annotated by the selection made by the bidder. In essence, the point is to store, in a compact fashion, the item the buyer is interested in so that the buyer's interest can be conveyed to the seller. Although display 112 itself could be stored with the annotation of cursor 113, the data required in that approach to store every bid and upload it to the server from the client application would be inefficient. Since both buyers and sellers will have access to the presentation, all that the seller requires from the buyer is the offset in order for the buyer's interest to be passed on to the seller. As such, the offset and the presentation can be considered a minimally required set of inputs for a function to generate at least a portion of the second image sufficient to display the item of interest to the seller.

The offset and presentation can be used to create an image for the seller in various ways. With the example of FIG. 3 in mind, the image created for the seller can be the image on display 300 annotated with cursor 301 applied to the image using the stored offset. In other approaches, the image can be just a portion of the image on display 300 in the vicinity of the location. For example, where the user defines the location in the form of an area, just that area of the image could be reproduced for the seller. In another example, where the user defines a location a cursor or highlighting could be included to annotate the drawing but the entire image to which the offset is applied would not be provided to the user as the image would be cropped to a standard size.

As shown in process 110, step 114 can be followed by step 115 of accepting a bid via the client application. The bid can be for one of the at least two items of physical merchandise that were displayed in image 112. In particular, the bid can be for the item that was identified by the selection received in step 111. Accepting the bid can be done using a bid entry interface such as the one in display 116. The bid can be a dollar amount that a potential buyer is willing to pay for the identified item. However, the bid can also include additional information. Process 110 can include a step 117 in which a text string is entered in the bid entry interface. The context windows described with reference to the navigation interface can include information from the seller regarding ranges of acceptable bids for items in the physical environment to aid the buyer in making decisions regarding what amount to bid.

The bid entry interface can include instructions for the user to enter text strings that include information such as: a brief name/description of the item pictured that they want to purchase, a quantity of the item to be purchased, customization options for the item such as size and color information, one or more declarations of limits or conditions of purchase that the customer wishes to place and the bid. The description is an optional field but it can be useful in that it assures the correct item has been identified by the offset received during the selection process. The instructions can indicate that the bid is inclusive of shipping and all applicable taxes. Other limitations on the transaction can also be presented to the bidder via the bid interface such that the offer sets what the customer is willing and will agree to pay for the item, assuming offer acceptance, availability, and that all customer specified conditions can be met.

The limitations placed on acceptance of the bid can take various forms. These limitations can include a temporal limitation such as that the bid must be accepted in the next two days. The limitations can also be based on a characteristic of the one of the at least two items of physical merchandise. Multiple limitations can be placed all of which can effectively phrased in the form of conditions that must be met for the offer to buy or bid to be valid. For example, a customer may enter: “I only want to purchase this item if it is between M and N inches tall, is made of X, by Y company, weighs less than P, and has characteristics Q, R, S, and T.” Instead of text strings, all information provided via the bid interface can be provided via user interface elements such as pull down menus or radio buttons.

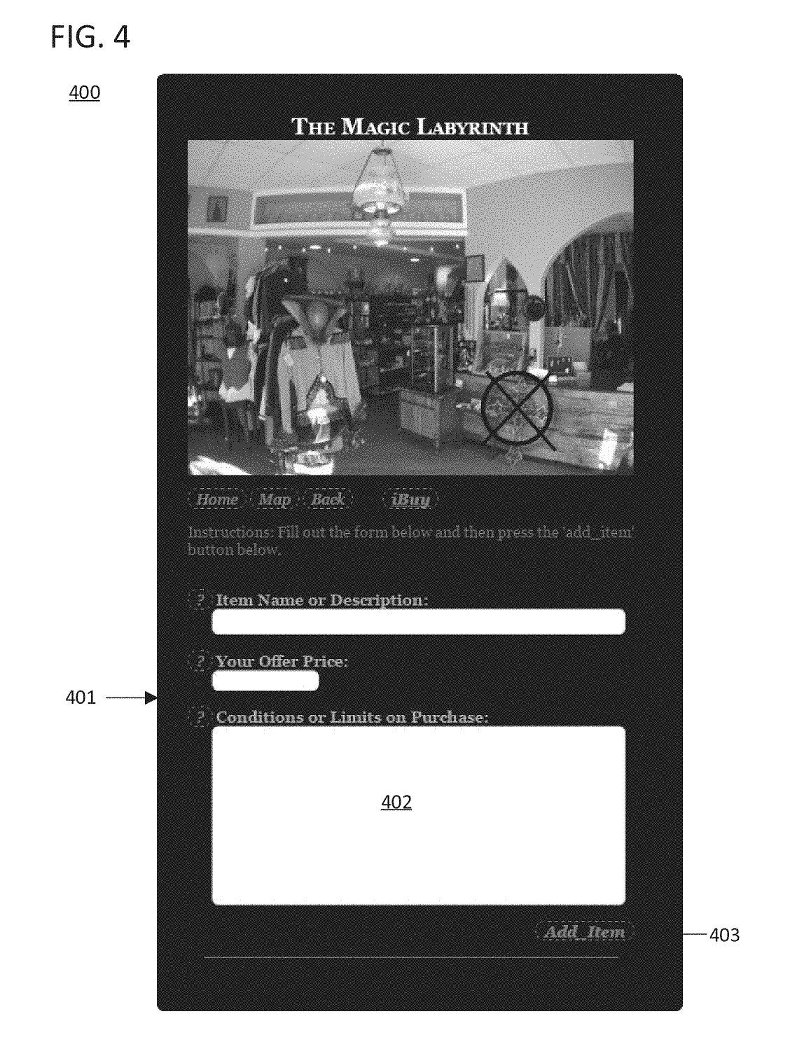

FIG. 4 illustrates exemplary bid entry interface 401 on display 400 which include text boxes for some of the types of information described above. In particular, bid entry interface 401 includes text box 402 to accept descriptions of limitations on acceptance for the bid as described above. Display 400 also includes an “add item” button 403 to allow the buyer to submit the bid they have created using bid entry interface 401.

Process 110 can continue with step 118 in which the bid package is stored in a memory. The bid package includes a text string entered in step 117, the bid, the set of coordinates from step 114, and a user identifier that uniquely identifies the user placing the bid. The coordinates or offset can be pulled from a temporary cache of a web browser or another memory administrated by the client application. The bid package associates the data mentioned above so that it can be recalled and manipulated by an individual computer or computer network as a unitary whole. The memory in which the bid package is stored can also be the temporary cache of a web browser or another memory administrated by the client application. For example, the memory could be a system memory of a device running the client application.

The unique identifier can be added to the bid package in numerous ways. For example, a user can be required to enter personal information such as a payment account number of a unique identifier accessible to the server as a condition to closing the bid entry interface. To use the example of FIG. 4, a user might need to enter their payment information before being allowed to select button 403. As another example, the user's overall interaction with the aforementioned technology can be premised upon the user providing a credential in a login step 121 which can be conducted before rendering the first image in step 102. The user identifier can then be stored in a temporary cache for later addition to the bid package in step 120. As another example, the user identifier can be created the first time the user downloads the client application to their client device from the server as in step 122. Note that steps 121, 122, and 107 can be conducted in any order which is why they are drawn with interconnecting arrows.

Flow chart 100 continues with process 130 in which the bid package 131 is uploaded from the client application to the server. The communication with the web server can be via an HTTP Post or web socket streaming. The server to which the bid package is uploaded can be administrated by the facilitator and can store the bid package in an encrypted format. Indeed, the client application and the server can communicate all bid information via some form of public or private key encryption protocol.

In specific approaches, a user can loop through processes 101 and 110 multiple times and bid on multiple items before uploading any information to the server. These iterations can be assist by a shopping cart feature which collects either the coordinates the user has provided or entire bid packages. The navigation interface can include a specific interface element to indicate that the buyer is “done” or would like to “checkout” to close the presentation and complete their order through a web checkout process. In the situation where only the coordinates are collected, the checkout process using the customer's cart could involve filling out the information required to complete the bid package. At this point, the buyer could also enter in shipping and payment information (such as a credit card number). However, shipping and payment information could also be auto associated with the order if that information was stored ahead of time with the system.

The technology described above allows a buyer, through the use of a virtual spatially navigable presentation of a physical location, to express interest in an unindexed globally declared item that is visible in the presentation. For the seller's benefit, this allows the buyer to express interest in items that might not even be physically in stock at the physical location such that without the disclosed technology, someone moving through the store would never know that item was available. The buyer can even express interest in items that the seller had not thought of selling. Furthermore, since only the coordinates or offset need to be transmitted through the network, the disclosed technology facilitates an image-based discussion regarding items available at the physical location in a less resource intensive manner.

Server-Side Technical Methods And Systems

FIG. 1 and the prior section illustrated how a client application can allow a user to download a virtual physically navigable presentation of a physical space, navigate through the presentation, and upload a bid package 131 to the server. As mentioned previously, the server that interfaces with the client application and client device can be administrated by a facilitator of the overall transaction and process. This section describes numerous other technological aspects of the facilitator's servers that allow both buyers and sellers to set up and use the overall system.

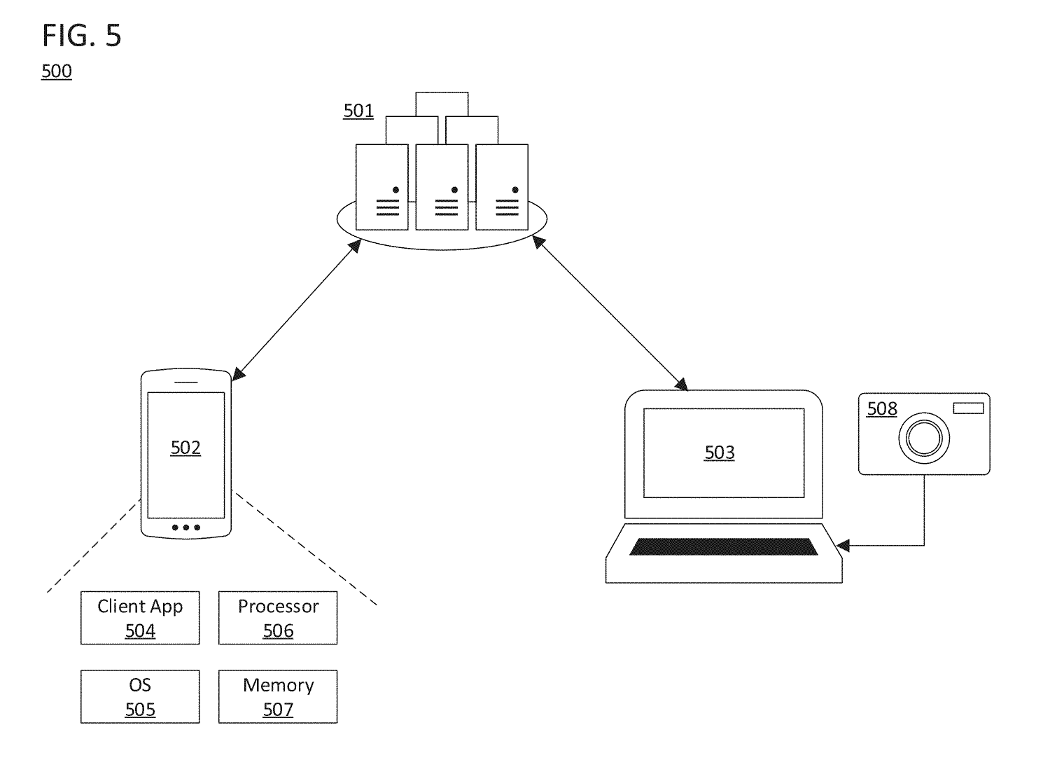

FIG. 5 illustrates a network diagram 500 which includes server means 501, a client device 502, and a seller device 503. The client application described in the prior section can operate on client device 502 in combination with server means 501. The client device 502 can be any kind of computing device with a user input interface and display such as a smartphone, laptop, workstation, or specialized kiosk. Client application 504 can be run by an operating system 505 of device 502. Both the operating system 505 and client application 504 can be instantiated using a processor 506 and a memory 507. Server means 501 can be administrated by the facilitator. Seller device 503 can be any kind of computing device with a user input interface and display such as a smartphone, laptop, workstation, or specialized kiosk. Seller device 503 can also communicate with a camera 508. Camera 508 can be integrated with seller device 503 or it can store images that are later uploaded to seller device 503 for transmission to server means 501.

The nodes of network diagram 500 can be connected by any known networking technologies and protocols. Each branch of the diagram can include the Internet. The information provided by the server and rendered by client device 502 or seller device 503 could be provided using FTP or HTTP and instructions encoded in HTML, CSS, and Javascript. The nodes of network diagram 500 can communicate via a TCP/IP or UDP/IP connection. The client device 502 and seller device 503 information to the server using an HTTP Post or web socket streaming.

Server means 501 can be any system of software and suitable computer hardware that is capable of responding to requests across a network to provide a network service. Although, server means 501 is illustrated as a single collection of physical hardware, server means 501 may comprise multiple disparate physical hardware units. The physical hardware units can include personal computers, workstation, and dedicated enterprise server blades. The physical hardware units can be in a single physical location such as an office or data center, but they may also be located at separate data centers or offices. The server means can be a virtualized server. Individual network service can be provided by individual servers or multiple servers, as well as individual units of physical hardware or multiple units of physical hardware. As the term “server means” is used to describe a system that provides multiple network services in certain portions of this disclosure, it is implied that the multiple network services are not necessarily being supplied by a single unit of physical hardware.

Server means 501 can communicate with client application 504 to enable client application to execute the methods of FIG. 1. As mentioned previously, the facilitator's servers can store the presentation needed for process 101 and 110, provide the client application via a download 122, administrate a login procedure for a user of the client application as in 121, and receive bid package 131 via process 130.

Server means 501 can also communicate with client device 502, or any other computing device operated by a buyer, to provide a buyer portal to potential buyers on the system. The buyer portal can be used by a buyer to set up an account with the facilitator. The account can include the user identifier that will be attached to bid packages produced by the buyer. The account can also include shipping information and payment information for the buyer that are stored by the facilitator to provide a more seamless checkout or bid creation process for the buyer. The account can also include an email address to be used to receive communications from a potential seller after the facilitator has delivered the buyers bid package to that seller. The buyer portal can also provide a landing page for the client application. The landing page can include a searchable index of stores that the buyer can access, an order management interface, and other account management features.

Server means 501 can communicate with seller device 503 to provide a seller portal to potential sellers on the system. In certain approaches, the same portal will be provided to both sellers and buyers, who can be collectively referred to as members of the system. As such, the seller portal can include all the features of the buyer portal mentioned above. However, the seller portal can also include a presentation or image upload feature and a bid package review feature. The images or presentation can be captured by camera 508 and uploaded via seller device 503.

Seller onboarding can be conducted in a similar fashion to creating an account for a buyer except the seller will have to upload images of the physical space containing the items they wish to sell. The seller can also provide some basic information concerning their store or physical space so that it can be searched from a high level index of the system. The image capture and upload process can involve a sweep of camera 508 through a physical space capturing a sequence of images that show the physical space. That sequence of images can be processed by seller device or directly uploaded to server 501 for processing. Processing can involve breaking the sequence of image into a smaller set of still images that will represent the waypoints of the presentation or the sequence of images provided in a linear tour of the physical space. However, processing can also include applying an image stitching algorithm to the sequence of images to provide a more fluid experience for touring the physical space.

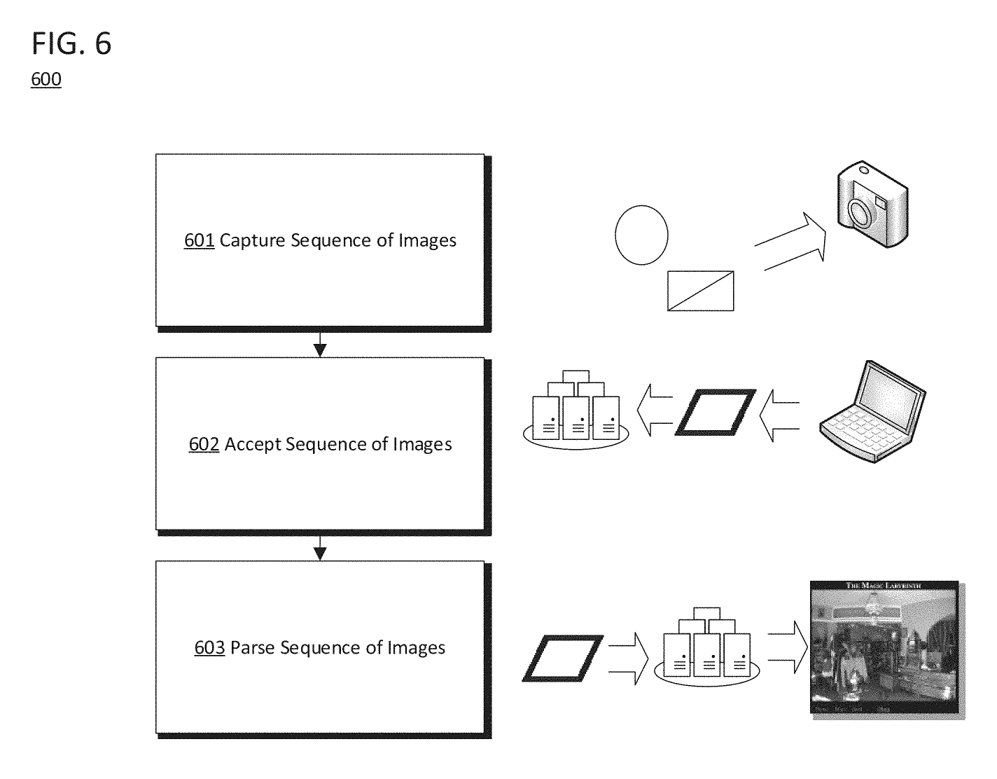

In a particular approach illustrated by flow chart 600 in FIG. 6, the processing will take place on server means 501. In step 601, camera 508 captures a sequence of images of the physical environment. The sequence of images can be frames in a video or still pictures taken by the camera at select points in the physical environment. In step 602, the sequence of images of the physical environment is accepted via a network connection. Server means 501 can accept the images over a network connection to seller device 503. In step 603, the sequence of images are parsed to generate the first and second images needed for the execution of the methods in FIG. 1. Parsing can involve a manual process facilitated by the seller portal where the seller selects specific images to include in the presentation. Parsing can also involve an automatic process using image stitching algorithms to create a free navigation presentation of the physical environment. The sweep can involve a person moving through the space with a video camera directed at the items that are for sale or with a still camera taking select pictures of the items that are for sale.

Server means 501 can deliver bid packages to sellers and can otherwise facilitate communication between the seller and buyer and the consummation of a transaction between the two. Server means 501 can deliver bid package 131 to a seller interface. The seller interface can be accessed via the seller portal or it can be embedded in an email sent from server means 501 to the seller's registered email address. Server means 501 can also receive a bid approval command via the seller interface. The bid approval command can be received via a hyperlink or user interface element in the seller interface which allows the seller to provide approval for a specific bid package. In response, to the bid approval command server means 501 can also transmit a bid approval message using the buyer's user identifier as attached to bid package 131.

Bid packages can be delivered to the seller or a store administrator in bulk for fulfillment. A copy of the bid packages, or a summary thereof, along with a total can be sent to the seller to facilitate this process via the seller's registered email address or via the seller portal as accessed via seller device 503. The store administrator, or team, can review each bid package and item to make an approval or deny decision for each item. For example, if an item is no longer available or does not meet all of the criteria specified by the customer, the bid could be denied. Notably, the seller will warrant that the bid criteria are met if they elect to approve the bid package. Server means 501 can also provide a channel for the seller to propose a counter bid to buyer which can be delivered the buyer via the buyer's registered email or via the order interface in the buyer portal.

If any bid packages are accepted by the seller, server means 501 can also administrate payment and fulfillment. Once all of the bid packages have been reviewed, server means 501 can administrate a transfer of funds from the buyer to the seller via the buyer's selected payment methods. The selected items can then be located and shipped. The shipping information can be provided by server means to the buyer and seller or it can be uploaded by the seller to the server means and passed on to the buyer. The buyer can receive a confirmation of shipping, a notice of a paid invoice, and a tracking number if available. The seller's orders can also be tracked via an orders interface on the seller portal which can show the status of fulfillment and payment for each bid package.

The methods executed by client device 502, server means 501, and seller device 503 can be executed by instructions in combination with a memory and a processor. A computer-readable non-transitory medium that can store these instructions. Server means 501 may have access, or may include, this computer-readable non-transitory medium which may be located on a single hardware device or distributed across multiple disparate hardware devices. A portion of the medium can store the instructions necessary to instantiate client application itself for download to client device 502. Another portion of the medium can store the instructions necessary to instantiate the seller and buyer portals mentioned above. Another portion of the medium can store the instructions necessary to receive and process the sequence of images captured by camera 508 to generate the presentation.

The technology disclosed with reference to FIGS. 5 and 6 enable buyer-pushed transactions with truly minimal effort required on the part of the seller. As generation of the presentation of the physical environment can be handled on the server side, all the seller needs to do is capture images of their items and upload them. In addition, since server means 501 can accept images in the form of a video stream or sequence of images, the seller, or someone operating on behalf of the seller, can simply sweep the video camera or image capture device through their environment to gather all of the data needed to create the presentation. Finally, the fact that in some instances buyers are required to register with the server, provides an efficient way to initiate contact between the buyer and seller without the buyer having to input contact information every time they place a bid.

Business-Method Utilizing Aspects of the Disclosed Technology

The technology described in the previous sections can be utilized in a business method for facilitating a buyer-pushed sales transaction between a buyer and a seller. The transaction is buyer-pushed in that the buyer identifies the item that will be the subject of the transaction from a set of globally declared unindexed items using the coordinates described in the previous section. Furthermore, the transaction is buyer pushed as the buyer controls the characteristics of the opening offer because the bid package includes a bid amount and a limitation on acceptance of the bid which is based on a characteristic of the item. The facilitator of the business method can support the entire transaction from onboarding of the buyer and seller, enabling browsing of the virtual physically navigable environments described above, to handling fulfillment shipping and payment. The facilitator can conduct these actions through employees of the facilitator or through independent contractors serving as agents under the direction of the facilitator in execution of the overall method. The facilitator can also facilitate execution of the method by conditioning participation in the overall transaction or receipt of a benefit upon performance of a step or steps of the disclosed business method and establishing the manner or timing of that performance.

Flow chart 700 illustrates various nodes in a flow chart of an overall business method for facilitating a buyer-pushed sales transaction between a buyer 701 and a seller 702. The nodes can be referred to as both a physical location and the actor associated with that physical location. For example, 702 can represent both the seller's store and the seller. The seller 702 is located at a physical location containing at least two items of physical merchandise that the seller would like to offer for sale. The physical location can be a residence, a flea market, a stand-alone brick and motor store, a large department store, a mall, a garage sale, or any other physical location with physical items for sale.

The various methods illustrated by flow chart 700 can begin by on-boarding a presentation of the seller's physical location 702. On-boarding the presentation can involve collecting a sequence of images at the seller's physical location 702 using capture hardware and processing the set of images to create a virtual spatially navigable presentation of the physical location 702. The presentation can then be offered via server means 703 which can have the same characteristics as server means 501.

The sequence of images can be collected in various ways. In certain methods, a seller can capture images of the seller's physical location 702 on their own using a camera or a specialized application on a smartphone, or other device, provided by the facilitator to serve as the capture hardware. The seller can move through the physical environment and capture a sequence of still images or a video. The seller can also provide a voice over during the capture to describe what is being shown that can also be captured by the camera or smartphone. In other approaches, a technician 704 is notified of the seller's physical location and handles the capture process.

The technician can dispatch capture hardware 705 to the seller's physical location 702. The capture hardware can be a specialized camera used to capture the sequence of images of the seller's location 702. The use of a technician can be beneficial in that they will have access to specialized capture hardware as described below to facilitate a more detailed presentation of seller's environment 702. The technician will also have special expertise in conducting such captures and can guide the seller in providing the audio voice over for the capture, and any additional information the seller might want to provide with the presentation that can be provided in the context windows mentioned above in the first section.

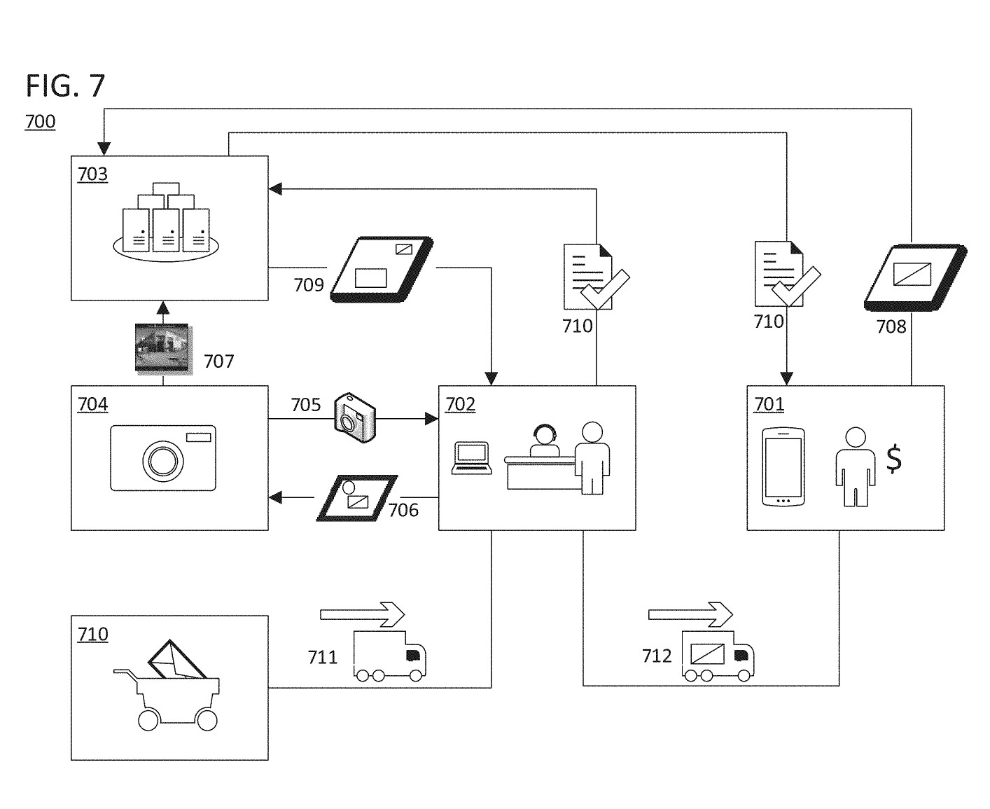

The sequence of images can be processed and uploaded in various ways. The technician 704 or seller 702 can directly upload the sequence of images to server means 703, or process them as described with reference to FIG. 6 before uploading them. The technician may also, as illustrated in FIG. 7, return the sequence of images 706 as stored on a hard drive to the technician's location 704 to then upload them to server means 703. The technician may have computer hardware and processing or editing resources at the technician's location 704 that are particularly suited to parsing the sequence of images to generate a presentation. The seller may be able to process the sequence of images using an application on a smartphone or provided via a seller portal by server means 703. As illustrated, server means 703 receives an upload package 707 from technician 704. In the illustrated case, server means 703 has already processed the sequence of images captured at the seller's location to create a virtual spatially navigable presentation of the physical location. However, the server means 703 could have received the sequence of images from the seller and then processed the sequence of images captured at the seller's location to create a virtual spatially navigable presentation of the physical location.

In an embodiment, navigation photographs are collected using specialized hardware such as a multi-camera hardware system. The hardware can also involve cameras with wide angle lenses so as to reduce the number of photographs collected per location. As one example, the wide angle lenses could capture 8 rotation directions from a set way point at center, low and high angles to provide a full spherical free look presentation with only 24 images per way point. A tripod and camera fixture can be used to ensure accurate placement of photograph origin, angle, and rotation. The hardware can also include wide angle video cameras arranged in such a way that an entire physical location is captured by carrying the hardware through the space a single time.

Once the presentation has been prepared, sever means 703 can provide, using data received in an upload package from either the seller or the technician a virtual spatially navigable presentation of the physical location to the buyer via a client application. The data can be provided via upload package 707. The manner in which buyer 701 interacts with the presentation in the client application can be as described with respect to FIG. 1. Thereby, once buyer 701 has found an item they are interested in they can upload a bid package 708 to server means 703. As a result, server means 703 will receive a set of coordinates as part of a bid package for an item in the set of at least two items offered by seller 702 from buyer 701.

Server means 703 will then handle transmitting the buyer's interest in the item to the seller. This can involve processing the bid package 708 to make it more presentable to the seller and facilitating identification of the item the buyer is interested in to seller 701 using the coordinates in bid package 708. This facilitation can involve formatting and sending an email 709 to seller 702 or providing the information via the seller portal described above. The email and seller portal can present this information as described in the previous section. Regardless of the format used, the bid package 708 can be delivered to seller 702 for the seller to consider as described in the previous section.

Certain methods of flow chart 700 can continue in different ways based on how the seller responds to the bid package and how the facilitator handles communications between seller 702 and buyer 701. In one approach, the facilitator will not restrict seller 702 from reaching out directly to buyer 701 in order to make the system as flexible as possible to its users. This could in fact be facilitated by allowing the buyer to opt in to delivery of their contact information to the seller along with the bid package. In other approaches, the seller will need to communicate with the buyer via server means 703. The seller can transmit a bid acceptance, a bid denial, or a counter offer via a communication 710 which is received by server means 703.

In response to a bid acceptance received from the seller, the facilitator can notify a shipper of the identity of the item. The notification can be delivered via server means 703. The notification can include the location of the seller and the buyer. In certain approaches shipper 710 will be an independent shipping company. In other approaches, shipper 710, technician 704, or both are employees of the facilitator. In certain approaches shipper 710 and technician 704 are the same entity working out of an office administrated by the facilitator. Regardless, shipper 710 may reach out to seller 702 to obtain additional information concerning the item that might not be apparent from the image. This communication could be administrated through server means 703. The shipper 710 can then optionally provide a shipping cost to seller 702 to allow them a final chance to accept the bid from the buyer less the shipping costs. If the shipping cost is accepted, the shipper can be dispatched 711 to the seller's physical location 702 to retrieve the item. The shipper can then package the item and handle fulfillment, which would include shipping the item 712 to the buyer 701.

The bid acceptance or other communication 710 can also be provided back to buyer 701 via server means 703. This can provide an option for the buyer to consider and accept a counter offer, or to find out their bid has been denied or accepted. The buyer 701 could also be looped into the shipping decision once information regarding the shipping cost has been provided by shipper 710.

The approaches described above provide certain benefits that that they are provided in parallel with existing sales channels such as from garage sales or fixed locations. The items offered for sale can still be offered at the physical location, and if they are not sold, seller 702 can consider bids placed on the items remotely after close of business. In addition, sellers are encouraged to upload presentations to server means 703 because it provides another channel to advertise the products offered at seller location 702 even if the transaction is not consummated via server means 703. For example, if buyer 701 navigates through the available presentations on the client application they might see an item that is at a location which is actually within close physical proximity to their location. The buyer can then physically go to seller's location 702 to obtain the item. The potential for this kind of transaction will encourage more sellers to use the platform.

Revenue can be generated for the facilitator in various ways. Revenue can be generated by the facilitator by taking a commission on each transaction conducted via server means 703. Revenue can also be generated by charging members a fixed membership fee for access to the system. Revenue can also be generated by charging sellers a fixed fee every time a new sequence of images or presentation describing their location is uploaded.

The approaches described above can provide a near fully automated imaging system for virtual physically navigable spaces used to create a matching web-based virtual environment containing diverse collections of items in contest. These approaches also describe means to rapidly and easily collected associated time and position based narratives which are navigationally bound in context to that physically navigable space which enables a buyer 701 to browse the space with enriched information. These approaches facilitating the possibility of arbitrary transactions on arbitrarily situational imaged items in a collaborative bidding process with the seller 702. Method mirrors the natural psycho-dynamics associated with browsing a store and negotiating a trade with the merchant.

Specific seller environments 702 that can particularly benefit from the approaches described above include general retail store locations, private sales events such as yard, garage, and estate sales, hardware stores, auto part stores, and grocery stores. Hardware stores and auto part stores are a particularly interesting application because a user could simply identify a region of the store such as a rack of bolts, and then define a specific thread, length, size, material, etc. and leave it to the seller to counter and fulfill the order. Stores offering wide varieties of items such as grocery stores with high inventory costs or perishable items can also benefit from the disclosed approaches as that retail purchases and home delivery of items can be made by a third party service provider without having to maintain inventory or construct a detailed catalog website of all possible items and descriptions in the store. Finally, those offering private sale events will not have to worry about marketing or shipping details, and purchaser does not have to travel to the purchasing location to buy interesting things.

While the specification has been described in detail with respect to specific embodiments of the invention, it will be appreciated that those skilled in the art, upon attaining an understanding of the foregoing, may readily conceive of alterations to, variations of, and equivalents to these embodiments. These and other modifications and variations to the present invention may be practiced by those skilled in the art, without departing from the scope of the present invention, which is more particularly set forth in the appended claims.

What is claimed is:

1. A computerized method executed by a client application in communication with a server comprising:
rendering a first image of a physical environment in the client application;
accepting a navigation command via the client application;
rendering, in response to the navigation command, a second image of the physical environment in the client application, wherein at least two items of physical merchandise are visible in the second image;
accepting a selection of a location on the second image via the client application;
storing a set of coordinates in response to the selection;
accepting a bid via the client application; and
storing a bid package in a memory, wherein the bid package includes and associates: (i) the bid; (ii) the set of coordinates; and (iii) a user identifier;
wherein the bid is for one of the at least two items of physical merchandise and is placed by a user who is uniquely associated with the user identifier.

2. The computerized method of claim 1, further comprising:
receiving a log in credential prior to rendering the first image;
storing the user identifier in a temporary cache after receiving the log in credential; and
adding the user identifier to the bid package from the temporary cache.

3. The computerized method of claim 1, wherein:
the set of coordinates are a set of two numerical values that describe an x-coordinate and a y-coordinate on the second image;
the navigation command corresponds to a physical movement through the physical environment; and
a relationship between the first image and the second image correlates with the physical movement.

4. The computerized method of claim 1, further comprising:
rendering a navigation interface in the client application;
wherein the navigation interface provides a zoom command interface, a turn command interface, and an azimuth command interface; and
wherein the first image and the second image are in a set of components of a presentation of the physical environment.

5. The computerized method of claim 4, wherein
the set of coordinates are part of an offset with respect to the presentation;
the offset includes an azimuth value and a zoom value; and
the offset and the presentation are a minimally required set of inputs for a function to generate at least a portion of the second image.

6. The computerized method of claim 1, further comprising:
providing a navigation interface in the client application;
wherein the first image and the second image are part of a presentation of the physical environment;
wherein the set of coordinates are an offset with respect to the presentation;
wherein the offset includes an azimuth value and a zoom value; and
wherein the offset and the presentation are a minimally required set of inputs for a function to generate at least a portion of the second image.

7. The computerized method of claim 6, wherein:
the at least two items of physical merchandise are not indexed;
the at least two items of physical merchandize are not represented electronically on the Internet in any form besides their visual appearance in the presentation; and
the at least two items are individually purchasable.

8. The computerized method of claim 1:
the navigation command corresponds to a temporal transition in the physical environment; and
a relationship between the first image and the second image correlates with the temporal transition and does not include a spatial translation.

9. The computerized method of claim 1, wherein:
the first image includes the at least two items of physical merchandise from a first angle;
the second image includes the at least two items of physical merchandize from a second angle; and
the first angle and the second angle are not equal.

10. The computerized method of claim 1, further comprising:
downloading a presentation of the physical environment from the server before accepting the navigation command;
wherein the first image and the second images are part of the presentation of the physical environment.

11. The computerized method of claim 1, further comprising:
accepting a text string via a bid entry interface of the client application;
wherein the bid package includes and associates: (i) the text string; (ii) the bid;
(iii) the set of coordinates; and (iv) the user identifier; and
wherein the text string describes a limitation on acceptance of the bid which is based on a characteristic of the one of the at least two items of physical merchandise.

12. The computerized method of claim 1, further comprising:
uploading the bid package to the server; and
downloading the client application from the server;
wherein the client application is an Internet based web browser application.

13. A non-transitory computer-readable medium storing instructions for executing, in combination with a processor, a method comprising:
rendering a first image of a physical environment in a client application;
accepting a navigation command via the client application;
rendering, in response to the navigation command, a second image of the physical environment in the client application, wherein at least two items of physical merchandise are visible in the second image;
accepting a selection of a location on the second image via the client application;
storing a set of coordinates in response to the selection;
accepting a bid via the client application; and
storing a bid package in a memory, wherein the bid package includes and associates: (i) the bid; (ii) the set of coordinates; and (iii) a user identifier;
wherein the bid is for one of the at least two items of physical merchandise and is placed by a user who is uniquely associated with the user identifier.

14. The non-transitory computer-readable medium of claim 13, storing instructions for executing a second method comprising:
providing the bid package to a seller interface;
receiving a bid approval command via the seller interface; and
transmitting, in response to the bid approval command, a bid approval message using the user identifier.

15. The non-transitory computer-readable medium of claim 14, storing instructions for executing a third method comprising:
accepting a sequence of images of the physical bidding environment via a network connection; and
parsing the sequence of images to generate the first image and the second image.

16. A means for obtaining a bid from a user for an unindexed physical item:
a means for rendering a first image of a physical environment in a client application;
a means for accepting a navigation command via the client application;
a means for rendering, in response to the navigation command, a second image of the physical environment in the client application, wherein at least two items of physical merchandise are visible in the second image;
a means for accepting a selection of a location on the second image via the client application;
a means for storing a set of coordinates in response to the selection;
a means for accepting the bid via the client application; and
a means for storing a bid package, wherein the bid package includes and associates: (i) the bid; (ii) the set of coordinates; and (iii) a user identifier;
wherein the bid is for one of the at least two items of physical merchandise and is placed by a user who is uniquely associated with the user identifier; and
wherein the one of the at least two items of physical merchandise is the unindexed physical item.

17. A business method for facilitating a buyer-pushed sales transaction between a buyer and a seller comprising:
notifying a technician of a physical location containing a set of at least two items of physical merchandise;
receiving an upload package from the technician;
providing, using data in the upload package, a virtual spatially navigable presentation of the physical location to the buyer via a client application;
receiving a set of coordinates as part of a bid package for an item in the set of at least two items from the buyer, wherein the coordinates are determined based on a selection from the buyer on an image in the virtual spatially navigable presentation;
facilitating identification of the item by the seller using the coordinates; and
delivering data from the bid package to the seller.

18. The business method of claim 17, further comprising:
collecting a sequence of images at the physical location using a multi-camera hardware system; and
processing the sequence of images to create a virtual spatially navigable presentation of the physical location;
wherein the sequence of images is included in the upload package received from the technician.

19. The business method of claim 17, further comprising:
receiving a counter offer or a bid acceptance from the seller;
notifying, if the bid acceptance is received from the seller, a shipper of an identity of the item;
dispatching the shipper to the physical location to retrieve the item; and
shipping the item to the buyer.

20. The business method of claim 17, the transaction is buyer-pushed in that:
the buyer identifies the item in the set of at least two items using the coordinates; and
the bid package includes the bid and a limitation on acceptance of the bid which is based on a characteristic of the item.
